(19) United States
(12) Patent Application Publication
(10) Pub. No.: US 2007/0063525 A1
(43) Pub. Date: Mar. 22, 2007

(54) Slide-out assembly

(75) Inventor: Harvey Howells, Richardson, TX (US)

Correspondence Address: BRIDGESTONE AMERICAS HOLDING, INC., 1200 FIRESTONE PARKWAY, AKRON, OH, 44317, US

(73) Assignee: BFS Diversified Products, LLC

(21) Appl. No.: 11/521,806

(22) Filed: Sep. 15, 2006

Related U.S. Application Data
(60) Provisional application No. 60/717,828, filed on Sep. 16, 2005.

(51) Int. Cl. B60P 3/00

(52) U.S. Cl. 296/24.3

(57) ABSTRACT

An expandable container includes a container body (10) having a side (14). The side (14) is provided with an aperture (12). An expansion device (20) is provided and moves relative to the aperture (12) as by a connection mechanism (16). The expansion device (20) includes a top side (44) and a longitudinal side (42) where at least a portion of the top side (44) and longitudinal side (42) are seamless.

This application gains the benefit of U.S. Provisional Application No. 60/717,828, filed Sep. 16, 2005, which is incorporated herein by reference.

### FIELD) OF THE INVENTION

The present invention relates generally to containers having expansion devices. In particular, the present invention relates to slide-out assemblies for recreational vehicles.

### BACKGROUND OF THE INVENTION

Recreational vehicles are currently a popular means of travel. These vehicles have evolved since their conception and employ many of the modern conveniences of home including kitchen, living spaces, and full bathroom amenities. Due to the desire to add even more features, space is a major limiting factor in the construction thereof. One solution to this design problem is the use of slide-out assemblies. A recreational vehicle may include one or more slide-out assemblies located on either side of the vehicle. While driving, the slide-out assemblies are retracted in an inward position, allowing the vehicle to navigate conventional roads. Once stopped, the assemblies slide out, providing added living and recreational space.

While slide-out assemblies provide added utility and space, they do have limitations. The assemblies are typically constructed by first providing an aluminum frame and then mounting separate roof, side wall, and lower wall panels. These construction panels typically include fiberglass that is laminated to plywood, such as Lauan. The panels are attached to the frame using adhesives and screws. Typically, termination bars are provided in the areas where the panels abut in order to facilitate proper sealing. Termination bars are generally flattened U-shaped aluminum strips with holes machined in an interspersed manner. The termination bar is provided where the roof material transitions to the fiberglass of the side portion, and is screwed aforementioned portions. Caulk is applied in these joints to further seal the joint. Finally, insulation and finishing components are installed.

This construction has several significant drawbacks. First, the areas where the construction panels abut are very susceptible to leakage. This is particularly problematic at the location where the roof panel meets the vertical side wall panels. Additionally, this method of construction is very labor and cost intensive, requiring multiple construction steps and added components.

There is therefore a need to improve slide-out assembly construction to provide a more cost effective article with improved leak resistance.

### SUMMARY OF THE INVENTION

In one or more embodiments, the present invention provides an expandable container comprising a container body, where said container body includes a side, an aperture in said side of said container body, an expansion device, and a connection mechanism interrelating said container body and said expansion device for movement relative to said aperture, where said expansion device includes a top side and a longitudinal side, and where at least a portion of said top side and said longitudinal side are seamless between said longitudinal side and said top side.

In one or more embodiments, the present invention also provides a recreational vehicle comprising a vehicle body, where said vehicle body includes a side, an aperture in said side of said vehicle body, an expansion device including a frame and an external shell, and a connection mechanism interrelating said vehicle body and said expansion device for movement relative to said aperture, where said external shell includes a top side and a longitudinal side and where at least a portion of said top side and said longitudinal side are seamless between said longitudinal side and said top side.

### BRIEF DESCRIPTION OF THE DRAWINGS

FIG. 1 is a perspective exploded view of a container and expansion device according to one or more embodiments.

FIG. 2 is a perspective view of a connection mechanism of one embodiment of a construction of a slide-out assembly.

FIG. 3 is a sectional view of one embodiment of a slide-out assembly.

FIG. 4 is a sectional view of another embodiment of a slide-out assembly of the recreational vehicle with slide-out collars extended.

FIG. 5 is a front view of the recreational vehicle a with slide-out assembly extended.

### DETAILED DESCRIPTION OF ILLUSTRATIVE EMBODIMENTS

One or more embodiments of the present invention include an expandable container. The container may include at least one side including at least one aperture for receiving an expansion device. In one or more embodiments, the container may include multiple sides, and one or more of the sides may include multiple apertures for receiving an expansion device.

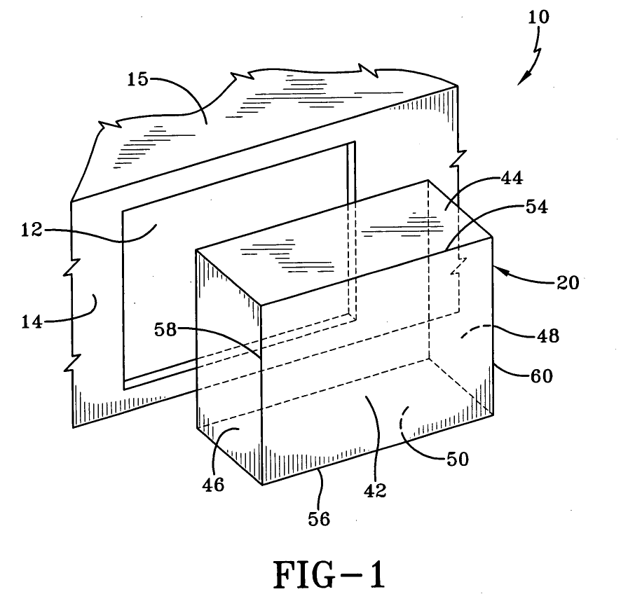

For example, as shown in FIG. 1, a container, which is generally represented by the numeral 10, includes an aperture 12 for receiving an expansion device, which is generally represented by the numeral 20. As shown, aperture 12 may be located in a longitudinal side 14 of container 10. Longitudinal side 14 may include a frame (not shown) and one or more panels. The frame may include wood, tubular metal (such as aluminum), or a combination thereof. The panels may include one or more outer layers, which may be exposed to environmental conditions, optionally one or more intermediary layers, and optionally one or more interior layers. The outer panel or layers, may include fiberglass, thermoplastic resin, or a combination thereof. Longitudinal side 14 may also include one or more layers of insulation (not shown). Container 10 may also include support devices in a bottom side (not shown) and/or a top side, which is generally represented by the numeral 15. These support devices may include joists (not shown).

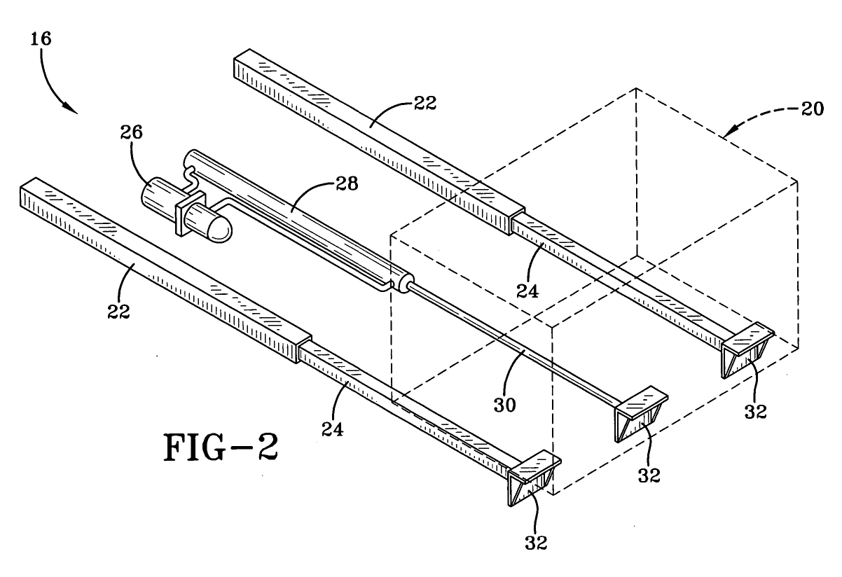

In one or more embodiments, container 10 and expansion device 20 may be connected by a connection mechanism 16, which may also be referred to as movement mechanism 16. Connection mechanism 16 may include a device for interrelating container 10 and expansion device 20 for movement relative to said aperture 12. One or more embodiments of the present invention are not limited by the selection of a particular mechanism. Many mechanisms for connecting container 10 to device 20 can be employed and are known in the art. FIG. 2 specifically depicts a hydraulic mechanism. Connection mechanism 16 includes a plurality of spaced rails 22 fixedly mounted to the container 10. Posts 24 may be slidably received in the hollow portions of rails 22 for movement therein. A hydraulic supply 26 may be provided which selectively supplies a chamber 28 with pressurized fluid. A piston 30 is received in the chamber 28 and is selectively actuated as is known in the art. Piston 28 and posts 24 include a bracket 32 on the ends thereof which provide a mounting surface for an expansion device 20. In this manner, expansion device 20 may be selectively moved relative to aperture 12. It should be appreciated that the connection mechanism of FIG. 2 is merely exemplary and any connection mechanisms may be used. Other connection mechanisms may include worm gears, rack and pinion gears and/or hinges.

As shown in the Figures, expansion device 20, which may also be referred to as slide out 20, may include a longitudinal side 42, a top side 44, a lateral side 46, a second lateral side 48 opposite to lateral side 46, and a bottom side 50 opposite to top side 44.

In one or more embodiments, longitudinal side 42 and top side 44 may intersect at top edge 54, longitudinal side 42 and bottom side 50 intersect may intersect at bottom edge 56, longitudinal side 42 and lateral side 46 may intersect at lateral edge 58, and longitudinal side 42 and lateral side 48 may intersect at lateral edge 60.

In one or more embodiments, longitudinal side 42 and top side 44 are seamless. In one or more embodiments, longitudinal side 42 and top side 44 include a single, integral piece. In these or other embodiments, longitudinal side 42 and bottom side 50 are seamless. In these or other embodiments, longitudinal side 42, top side 44, and bottom side 50 are seamless.

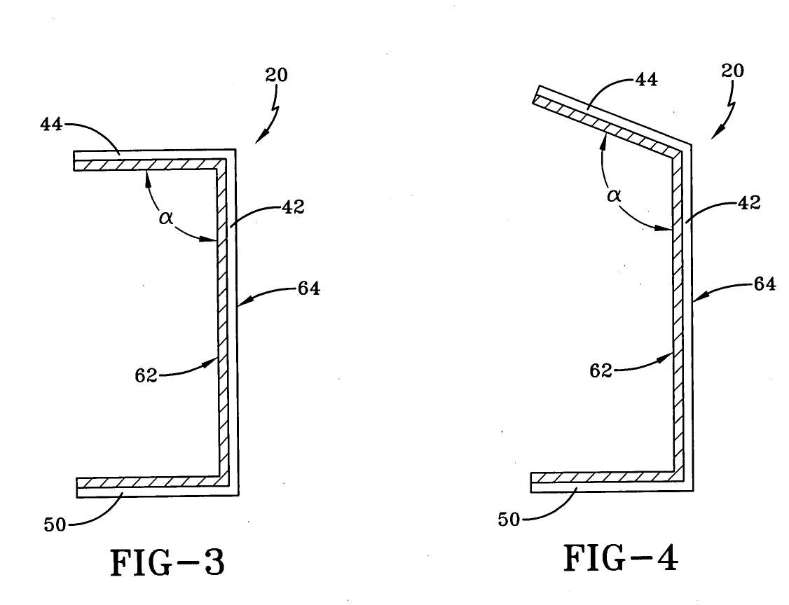

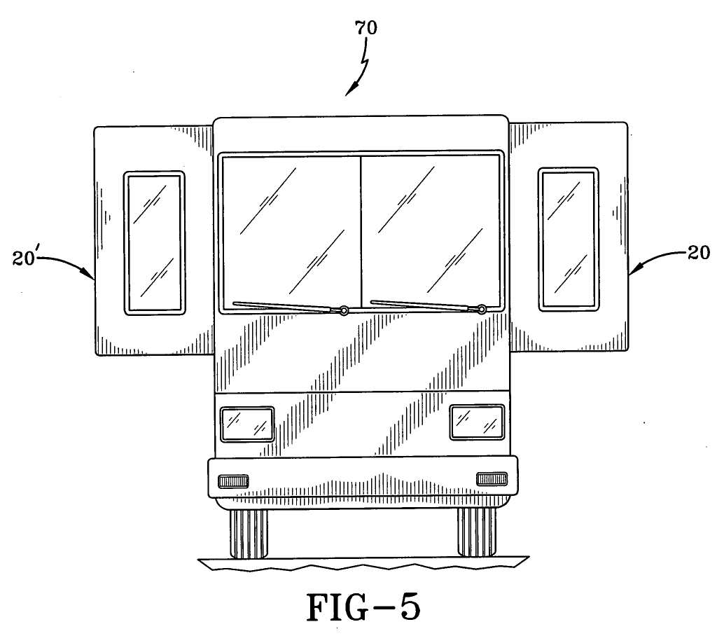

In one or more embodiments, as shown in FIG. 3, expansion device 20 may include a frame 62 and an external shell 64, the sides which may collectively be referred to as external sides. In one or more embodiments, two or more of longitudinal side 42, top side 44, lateral side 46, lateral side 48, and bottom side 50 may form external shell 64. Frame 62 may include a structure that can support or add integrity to external shell 64. Frame 62 may include wood, tubular metal (such as aluminum), or a combination thereof. In one or more embodiments, expansion device 20 may also include insulation, which may be interposed within interstices that may exist within frame 62.

In one or more embodiments, the seamless components of expansion device 20 (i.e. at least longitudinal side 42 and top side 44 of external shell 64) include a thermoformable material. In one or more embodiments, the thermoformable material includes a thermoplastic resin. In one or more embodiments, the thermoplastic resin is characterized by a coefficient of linear thermal expansion (CLTE), as measured according to ASTM D-696, of less than 2.5×10⁻⁵/in/in/° C., in other embodiments less than 1.5×10⁻⁵/in/in/° C., and in other embodiments less than 0.5×10⁻⁵/in/in/° C.

Useful thermoplastic resins include poly α-olefins such as, but not limited to, polyethylene or polypropylene, as well other thermoplastics such as polystyrene, acrylic resins such as, but not limited to, polymers or copolymers of acrylic acid, methacrylic acid, esters of these acids, acrylonitrile, or combinations thereof.

In one embodiment, the thermoplastic or thermoformable material may include a polymeric blend of a poly α-olefin and an acrylic resin. These blends may include from about 30 to about 80% by weight, in other embodiments from about 40 to about 70% by weight, and in other embodiments from about 45 to about 60% by weight poly α-olefin, and from about 70 to about 20% by weight, in other embodiments from about 60 to about 30% by weight, and in other embodiments from about 55 to about 40% by weight acrylic resin.

In one embodiment, the thermoplastic or thermoformable material includes a copolymer, including graft copolymers, of polypropylene and acrylic resins. For example, graft copolymers including an isotactic-polypropylene backbone having grafted thereto polystyrene, polyvinylacetate, polymethacrylate, polymethylmethacrylate, polyacrylonitirle, or a mixture thereof. In one or more embodiments, graft copolymers include from about 30 to about 70% by weight poly α-olefin and from about 70 to about 30% by weight acrylic resin, and in other embodiments from about 40 to about 60% by weight poly α-olefin and from about 60 to about 40% by weight acrylic resin. Useful graft copolymers include those disclosed in U.S. Pat. No. 6,617,410, which is incorporated herein by reference. Useful graft copolymers include those that are commercially available under the tradename Interloy™ W1095H1 (Crompton).

In one or more embodiments, the thickness of one or more of the external sides of expansion device 20 may be from about 1.5″ to about 4″, in other embodiments from about 2″ to about 3″, and in other embodiments from about 2.25″ to about 2.75″.

In one or more embodiments, as shown in FIGS. 3 and 4, longitudinal side 22 and top side 24 may form an internal angle α. This angle may be from about 95 degrees to about 110 degrees, and in other embodiments from about 100 degrees to about 105 degrees. In one or more embodiments, top side 44 and longitudinal side 42 are perpendicular. Where angle a is greater than 90 degrees, top side 44 will be pitched toward longitudinal side 42 as shown in FIG. 4. This may advantageously direct precipitation away from container 10.

In one or more embodiments, the two or more seamless external sides of expansion device 20 may be integrally formed by a process that includes extruding a sheet of thermoformable material, and then bending the sheet to form two sides and an edge. Once the sheet is formed, and optionally cooled, heat can be applied to a location of the sheet where an edge is desired (e.g. edge 54). Once the sheet is heated to a temperature that allows the material to bend at the desired location, sufficient stress or strain is applied to the sheet in an appropriate direction to form an appropriate angle or bend in the sheet, which can thereby form two sides (e.g. longitudinal side 42 and top side 44). In one or more embodiments, a straight edge or similar device can be employed to facilitate formation of the edge. In one or more embodiments, multiple edges (which would result in three or more. sides) can be formed in the sheet. For example, both edge 54 and edge 56 can be bent into the sheet, thereby forming longitudinal side 42, top side 44, and bottom side 50, which as a result of the process would all be seamless.

In one or more embodiments, the thickness of the extruded sheet may be from about 0.050 to about 0.200 inches, in other embodiments from about 0.100 to about 0.150 inches, and in other embodiments from about 0.110 to about 0.130 inches. In one or more embodiments, the temperature at which the desired location of the sheet is heated for purposes of forming an edge may be from about 200° F. to about 250° F., and in other embodiments from about 220° F. to about 230° F.

In one or more embodiments, the expandable container may include a mobile structure including, for example, a mobile home, a recreational vehicle, a recreational trailer, a truck trailer, and a marine vessel. For example, a recreational vehicle 70 is shown in FIG. 4 including slide out 20 and optional second slide out collar 20′.

Various modifications and alterations that do not depart from the scope and spirit of this invention will become apparent to those skilled in the art. This invention is not to be duly limited to the illustrative embodiments set forth herein.

What is claimed is:

1. An expandable container comprising:
a container body, where said container body includes a side;
an aperture in said side of said container body;
an expansion device; and
a connection mechanism interrelating said container body and said expansion device for movement relative to said aperture,
where said expansion device includes a top side and a longitudinal side, and where at least a portion of said top side and said longitudinal side are seamless between said longitudinal side and said top side.

2. The container of claim 1, where said expansion device includes a frame and an external shell.

3. The container of claim 1, where said external shell includes a bottom side, where said bottom and said longitudinal side of said external shell are seamless between said longitudinal side and said bottom side.

4. The container of claim 1, where said external shell includes a thermoplastic resin.

5. The container of claim 1, where said thermoplastic resin is characterized by a coefficient of linear thermal expansion of less than 2.5 /in/in/° C.

6. The container of claim 1, where the thickness of said external shell is from about 0.050 inches to about 0.200 inches.

7. The container of claim 1, where the expandable container includes a recreational vehicle or a recreational trailer.

8. The container of claim 1, where said external shell includes two lateral sides interposed between side top side and said bottom side, and where said lateral sides include a thermoplastic resin.

9. The container of claim 1, where said top side is positioned perpendicular to said longitudinal side.

10. The container of claim 1, where said top side and said longitudinal side are positioned to form an internal angle that is greater than 90 degrees.

11. The container of claim 10, where said internal angle is less than 105 degrees.

11. The container of claim 1, where said top side and said longitudinal side are prepared by extruding a single, integral member.

12. The container of claim 1, where said top side, said bottom side, and said longitudinal side are prepared by extruding a single, integral member.

13. A recreational vehicle comprising:
a vehicle body, where said vehicle body includes a side;
an aperture in said side of said vehicle body;
an expansion device including a frame and an external shell; and
a connection mechanism interrelating said vehicle body and said expansion device for movement relative to said aperture,
where said external shell includes a top side and a longitudinal side and where at least a portion of said top side and said longitudinal side are seamless between said longitudinal side and said top side.

14. The recreational vehicle of claim 13, where said external shell includes a bottom side, where said bottom and said longitudinal side of said external shell are seamless between said longitudinal side and said bottom side.

15. The recreational vehicle of claim 13, where said external shell includes a thermoplastic resin.

16. The recreational vehicle of claim 13, where said thermoplastic resin is characterized by a coefficient of linear thermal expansion of less than 2.5/in/in/° C.

17. The recreational vehicle of claim 13, where the thickness of said external shell is about 0.050 inches to about 0.200 inches.

18. The recreational vehicle of claim 13, where said external shell includes two lateral sides interposed between side top side and said bottom side, and where said lateral sides include a thermoplastic resin.

19. The recreational vehicle of claim 13, where said top side is positioned perpendicular to said longitudinal side.

21. The recreational vehicle of claim 13, where said top side and said longitudinal side are positioned to form an internal angle that is greater than 90 degrees.

22. The recreational vehicle of claim 21, where said internal angle is less than 105 degrees.

23. The recreational vehicle of claim 13, where said top side and said longitudinal side are prepared by extruding a single, integral member.

24. The recreational vehicle of claim 13, where said top side, said bottom side, and said longitudinal side are prepared by extruding a single, integral member.
